(19) United States
(12) Patent Application Publication
(10) Pub. No.: US 2013/0083432 A1
(43) Pub. Date: Apr. 4, 2013

(54) MAGNETIC BIAS STRUCTURE FOR MAGNETORESISTIVE SENSOR

(71) Applicants: Quang Le, San Jose, CA (US); Simon H. Liao, Fremont, CA (US); Shuxia Wang, San Jose, CA (US); Guangli Liu, Pleasanton, CA (US); Yongchul Ahn, San Jose, CA (US)

(72) Inventors: Quang Le, San Jose, CA (US); Simon H. Liao, Fremont, CA (US); Shuxia Wang, San Jose, CA (US); Guangli Liu, Pleasanton, CA (US); Yongchul Ahn, San Jose, CA (US)

(73) Assignee: Hitachi Global Storage Technologies Netherlands B.V., Amsterdam (NL)

(21) Appl. No.: 13/249,076

(22) Filed: Sep. 29, 2011

(51) Int. Cl. G11B 5/60; G11B 5/127

(52) U.S. Cl. 360/235.4; 29/603.16; G9B/5.229

(57) ABSTRACT

A magnetic read head having a hard bias structure that both optimizes magnetic bias field and also ensures manufacturability while maintaining sensor stripe height integrity. The read head includes a sensor stack having a back edge and first and second laterally opposed sides. A hard bias structure extending from each of the first and second sides of the sensor stack has a neck portion located near the sensor and having a back edge that is aligned with and parallel to the back edge of the sensor stack. The hard bias structure also includes a flared portion having a back edge that defines an angle relative to the air bearing surface of the read head. The back edge preferably defines and angle of 45-75 degrees relative to the air bearing surface.

### FIELD OF THE INVENTION

The present invention relates to magnetic data recording and more particularly to a magnetic read head having a magnetic bias structure that provides increased magnetic bias field while also ensuring manufacturability.

### BACKGROUND OF THE INVENTION

The heart of a computer is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider into contact with the surface of the disk when the disk is not rotating, but when the disk rotates, air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing acrd reading functions.

The write head includes at least one coil, a write pole and one or more return poles. When a current flows through the coil, a resulting magnetic field causes a magnetic flux to flow through the write pole, which results in a magnetic write field emitting from the tip of the write pole. This magnetic field is sufficiently strong that it locally magnetizes a portion of the adjacent magnetic disk, thereby recording a bit of data. The write field, then, travels through a magnetically soft under-layer of the magnetic medium to return to the return pole of the write head.

A magnetoresistive sensor such as a Giant Magnetoresistive (GMR) sensor, or a Tunnel Junction Magnetoresistive (TMR) sensor can be employed to read a magnetic signal from the magnetic media. The sensor includes a nonmagnetic conductive layer (if the sensor is a GMR sensor) or a thin nonmagnetic, electrically insulating barrier layer (if the sensor is a TMR sensor) sandwiched between first and second ferromagnetic layers, hereinafter referred to as a pinned layer and a free layer. Magnetic shields are positioned above and below the sensor stack and can also serve as first and second electrical leads so that the electrical current travels perpendicularly to the plane of the free layer, spacer layer and pinned layer (current perpendicular to the plane (CPP) mode of operation). The magnetization direction of the pinned layer is pinned perpendicular to the air bearing surface (ABS) and the magnetization direction of the free layer is located parallel to the ABS, but free to rotate in response to external magnetic fields. The magnetization of the pinned layer is typically pinned by exchange coupling with an antiferromagnetic layer.

When the magnetizations of the pinned and free layers are parallel with respect to one another, scattering of the conduction electrons is minimized and when the magnetizations of the pinned and free layer are antiparallel, scattering is maximized. In a read mode the resistance of the spin valve sensor changes about linearly with the magnitudes of the magnetic fields from the rotating disk. When a sense current is conducted through the spin valve sensor, resistance changes cause potential changes that are detected and processed as playback signals.

As magnetoresistive sensors become ever smaller in an effort to maximize data density the biasing of the free layers becomes ever more challenging. The smaller the free layer becomes, the more inherently unstable its magnetization becomes, and the smaller the bias structure is the weaker the bias field is. Therefore, there remains need for a structure that can provide a sufficiently strong bias field for maintaining free layer stability in very small sensors. This should also be achieved, however, in a manner that ensures manufacturability without degradation of sensor definition.

### SUMMARY OF THE INVENTION

The present invention provides a magnetic read head that includes a sensor stack having a front edge facing an air bearing surface, a back edge opposite the air bearing surface and first and second laterally opposed sides each extending from the front edge to the back edge. The read head also includes a magnetic bias structure extending laterally from each of the first and second sides of the sensor stack. The bias structure has a throat portion having a back edge that is aligned with the back edge of the sensor stack and a tapered portion extending laterally outward from the throat portion. The tapered portion has a back edge that extends away from the air bearing surface and that defines an angel with respect to a plane that is parallel with the air bearing surface.

The magnetic write head can be manufactured by a method that includes, depositing a series of sensor layers and then forming a first mask, configured to define a sensor width. A first ion milling is then performed to remove portions of the series of sensor layers not protected by the first mask. A magnetic hard bias material is then deposited, and the first mask is removed. A second mask is then formed which is configured to simultaneously define a back edge of the sensor and a hard bias structure having a throat portion with a back edge that is aligned with the back edge of the sensor and a tapered portion with a back edge oriented at an angle relative to an air bearing surface plane. A second ion milling is then performed to remove portions of the sensor material and magnetic hard bias material that are not protected by the second mask.

The formation of a novel hard bias structure as described above provides increased magnetic bias field strength, while also ensuring manufacturability of the structure without risk of damage to or deformation of the sensor stack. The flared portion of the hard bias structure increases the magnetic bias field to the sensor. The neck portion of the hard bias structure ensures that any misalignment between the first and second mask structures will not adversely affect the formation of the sensor back edge.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as ell as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider illustrating the location of a magnetic head thereon;

FIG. 3 is an enlarged ABS view of a magnetoresistive according to an embodiment of the invention;

FIG. 4 is a top down view of the sensor of FIG. 3. Showing a hard bias structure;

FIG. 5 is a table showing hard bias magnetic fields for various hard bias configurations; and

FIGS. 6-18 are views of a magnetoresistive sensor in various intermediate stages of manufacture, illustrating a method for manufacturing a magnetic sensor according to an embodiment of the invention.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

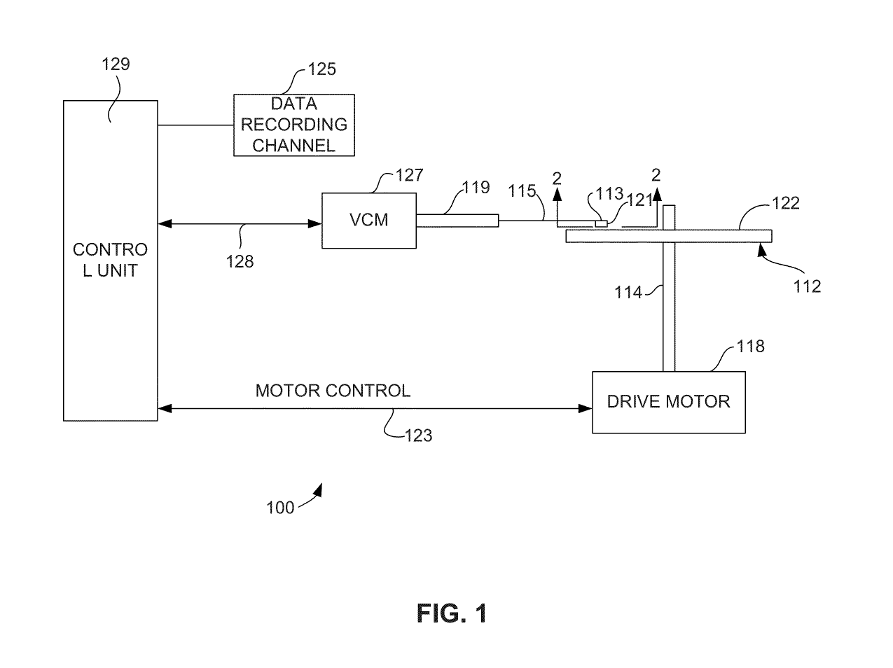

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 can access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal dock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

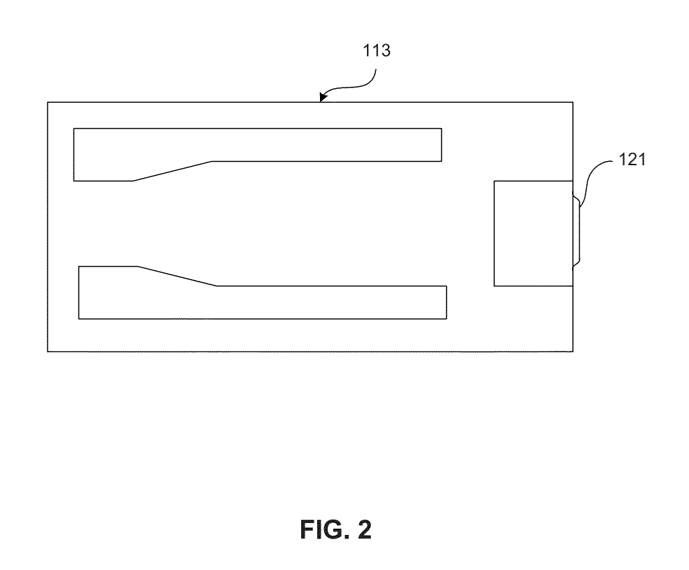

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system and the accompanying illustration of FIG. 1 are for representation purposes only. It should be apparent that disk storage systems may contain a large number of disks and actuators, and each actuator may support a number of sliders.

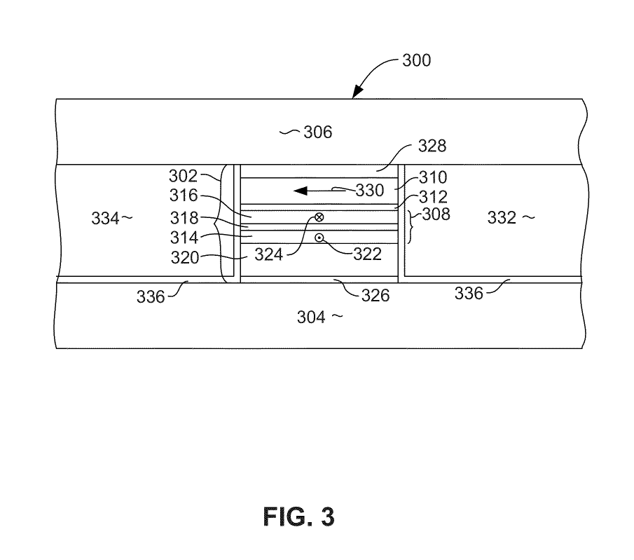

FIG. 3 shows a magnetic read head 300 having a sensor stack 320 that is sandwiched between first and second magnetic shields 304, 306. The magnetic shields 304, 306 can be constructed of an electrically conductive, magnetic material such as NiFe so that they can function as electrical leads for supplying a sense current to the sensor stack 320 as well as functioning as magnetic shields. The sensor stack can include a magnetic pinned layer structure 308, a magnetic free layer 310 and a non-magnetic barrier or spacer layer 312 sandwiched there-between. The sensor stack 302 can also include a seed layer 326 at its bottom, which can be provided to ensure a desired grain structure formation in the above deposited layers. The sensor stack 302 can also include a capping layer 328 at its top to protect the under-lying layers from damage during manufacture. The Capping layer 328 can be, for example, Ru or Ru/Ta/Ru.

The pinned layer structure can include first and second magnetic layers 314, 316 that are anti-parallel coupled across a non-magnetic antiparallel coupling layer 318 such as Ru. The first magnetic layer 314 can be exchange coupled with a layer of antiferromagnetic material (AFM layer) 320, which can be constructed of a material such as IrMn or PtMn. This exchange coupling strongly pins the magnetization of first magnetic layer 310 in a first direction perpendicular to the ABS as indicated by arrowhead symbol 322. Anti-parallel coupling between the magnetic layers 314, 316 pins the magnetization of the second magnetic layer 324 in a second direction that is anti-parallel with the first direction and perpendicular to the ABS as indicated by arrow-tail symbol 324.

The free layer 310 has a magnetization that is biased it a direction that is generally parallel with the ABS as indicated by arrow 330. Although the magnetization 330 is biased in this direction, it is free to move in response to an external magnetic field, such as from a magnetic medium.

The biasing of the magnetization 330 is achieved by a magnetic bias field from hard magnetic bias layers 332, 334. These magnetic bias layers 332, 334 are permanent magnets formed of a high coercivity magnetic material such as CoPt, or CoPtCr. The bias layers 332, 334 are separated from the sensor stack 302 and from at least the bottom shield 304 by a thin layer of non-magnetic, electrically insulating layers such as alumina 336, 338.

As discussed above, as sensors become ever smaller the biasing of the magnetization 330 of the free layer 310 becomes ever more difficult. The agnetic bias layers 332, 334 of the present invention have a configuration that maximizes the available magnetic bias field while also ensuring manufacturability without damage to the sensor.

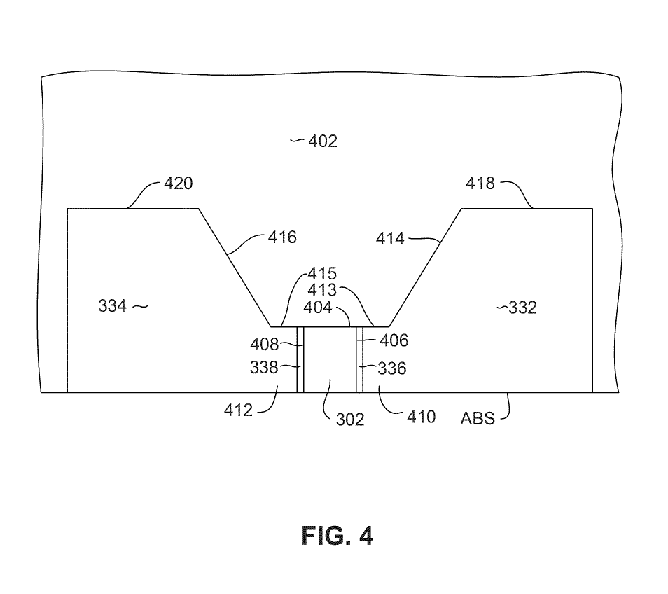

FIG. 4 shows a top down view of the structure of FIG. 3. FIG. 4 shows the bias layers 332, 334 extending laterally from the sides of the sensor stack 302 and being separated from the sensor 302 by the insulation layers 336, 338. The areas beyond the sensor 302 and bias structures 332, 334 can be filled with a non-magnetic, electrically insulating fill layer 402 such as alumina.

Also, as can be seen in FIG. 4, the sensor stack 302 has a back edge 404 opposite the air bearing surface (ABS), and first and second laterally opposed sides 406, 408. Each of the magnetic bias structures 332, 334 has a neck portion 410, 412 adjacent to the sides 406, 408 of the sensor 302. The neck portion 410, 412 of each of the hard bias structures 332, 334 has a back edge 413, 415 that is aligned with the back edge 404 of the sensor stack 302. Beyond the neck portion 410, 412, each of the hard bias structures 332, 334 has a flared portion with a back edge 414, 416 that tapers away from the ABS. The back edge 414, 416 preferably defines an angle of 60 degree nominal but can range 45-75 degrees relative to a plane that is parallel with the ABS. The tapered edge portion 414, 416 can end at a point removed from the sensor stack 404 so that the outermost portions of each of the hard bias structures 332, 334 can have a back edge 418, 420 that is substantially parallel with the ABS. The inventors have discovered that this configuration of hard bias layers 332, 334 provides an optimal balance of manufacturability, high bias field strength and sensor integrity, as will be described further herein below.

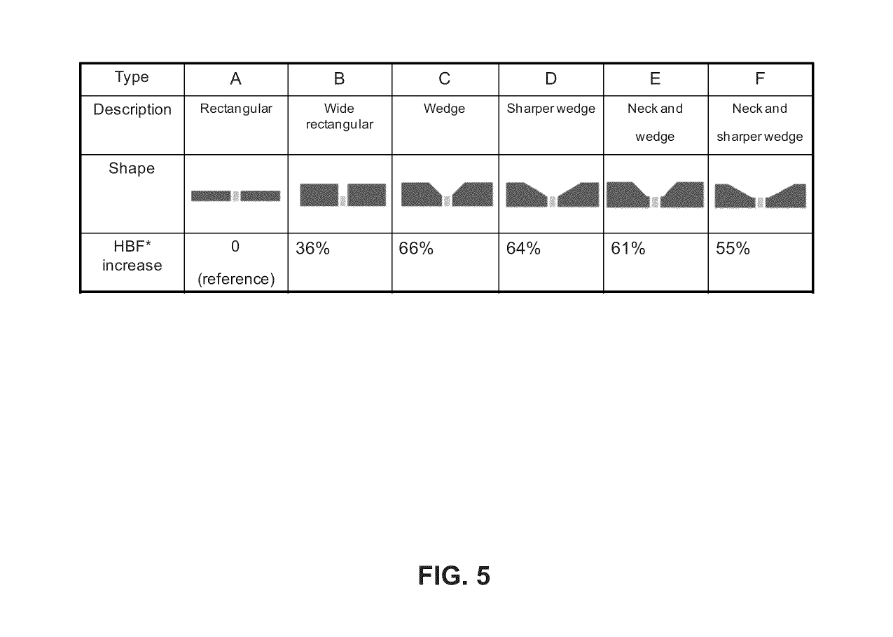

FIG. 5 shows a table that illustrates the magnetic bias field provided by various hard bias structures. Column A, which is used as reference structure, shows a standard hard bias structure that extends straight out from the sensor stack and does not extend beyond the back edge of the sensor stack. This structure, which is a standard structure most commonly found in magnetic heads is used as a reference configuration and is given a bias field of zero for comparison purposes.

Column B shows the bias field provided by a hard bias structure that extends beyond the back edge of the sensor stack, but which has a straight back edge, with no neck portion and no tapered portion. As can be seen, this hard bias structure provides a 36% increase in magnetic bias field over the reference structure of column A.

Columns C and D show the bias field for a structure having a flared portion, but no neck portion. In column C the bias structure has a back edge with a taper that defines a larger angle relative to the ABS, whereas in column D the bias structure has aback edge that defines a smaller angle relative to the ABS. As can be seen, both of these structures (columns C and D) provide the highest magnetic bias field. However, they also present potential challenges with regard to manufacturability. As will be better understood below, the back edge of the sensor and back edge of the hard bias structures are defined by a lithographic masking process. The mask used to form these structures must be aligned with a separate mask that was previously used to define the sides of the sensor stack. Of course perfect alignment of separate mask structures is not possible, so any misalignment of these masks (when using the structures of columns C and D will result in malformation of the bias structure as well as malformation of and damage to the sensor stack itself.

Columns E and F provide a hybrid bias structure which has a neck portion near the sensor and also has a flared portion. The structure of column E has a tapered back edge that defines a larger angle relative to the ABS (45-75 degrees but 60 degree nonmial) than the tapered back edge of the structure n F. As can be seen, the structure of column E has a greater bias field than the structure of column F. The structure of Column E provides a 61% increase over the reference structure of column A, which is almost as high as the bias field provided by the structure of column C. However, because the neck portion of the structure of column E is aligned with the back edge of the sensor stack, any slight lateral misalignment of the mask used to define the back edge of the sensor and the hard bias structures will not seriously, adversely affect either the bias structure or the sensor. This will be even clearer after discussion of a method for manufacturing a sensor as described herein below.

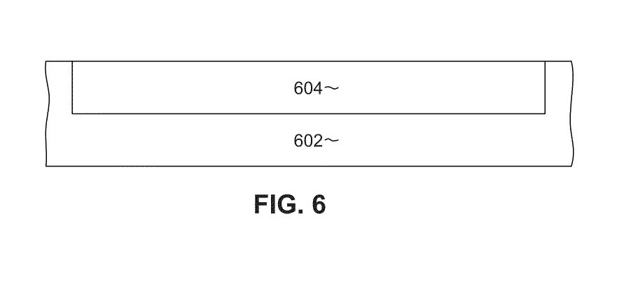

FIGS. 6-18 show a magnetic head in various intermediate stages of manufacture in order to illustrate a method for manufacturing a magnetic sensor according to an embodiment of the invention. With particular reference to FIG. 6, an electrically conductive magnetic shield 604 is formed into a substrate 602. The magnetic shield 604 can be constructed of a material such as NiFe and the substrate 602 can be a material such as alumina. The surfaces of the layers 604, 602 can be planarized, such as by chemical mechanical polishing (CMP), so that they have smooth, co-planar surfaces.

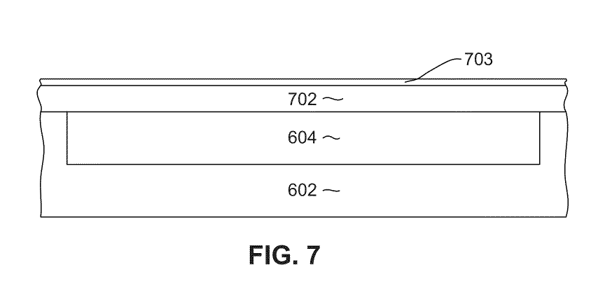

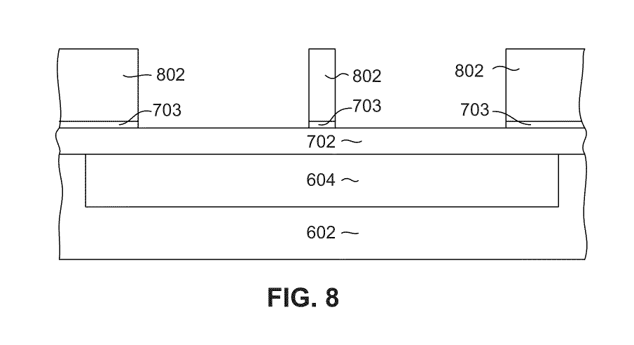

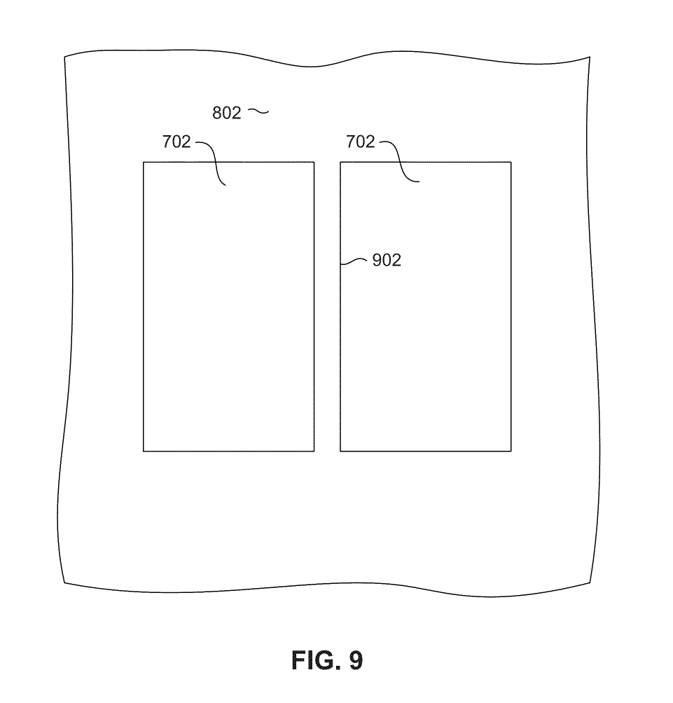

With reference to FIG. 7, a series of sensor layers 702 is deposited over the layers 604, 602. The sensor layers 702 can include the layers of the sensor stack 302, discussed above with reference to FIG. 3, or could include layers other sensor structures. The series of sensor layers 702 can also include, at its top, a layer of material that is resistant to chemical mechanical polishing 703, such as diamond like carbon (DLC) or amorphous carbon. As shown in FIG. 8, a first mask structure 802 is formed over the series of sensor layers 702 and CMP resistant layer 703. The mask structure can include various layers, such as a hard mask layer an image transfer layer, a bottom antireflective coating layer and a photoresist mask, although these individual layers are not shown in FIG. 8 for purposes of simplicity and clarity. The image of the mask 802 can be transferred onto the underlying CMP resistant layer 703 either by reactive ion etching or ion milling, depending on the material used for the layer 703. The configuration of the mask structure 802 can be better understood with reference to FIG. 9, which shows a top down view of the mask structure 802 and under-lying sensor layers 702. As seen in FIG. 9, the mask structure 802 has openings though with the under-lying sensor layers 702 can be seen. A central mask portion 902 between the two openings provides a sensor width defining mask portion.

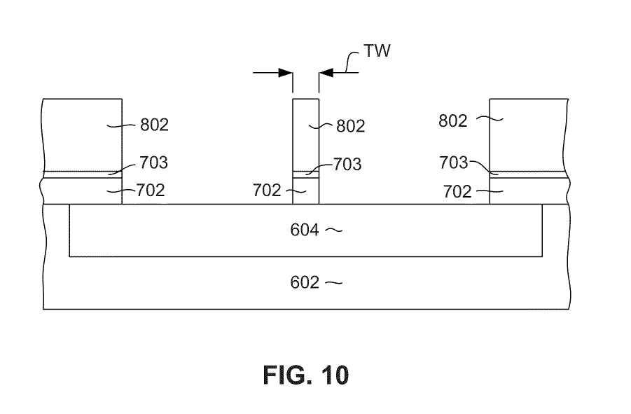

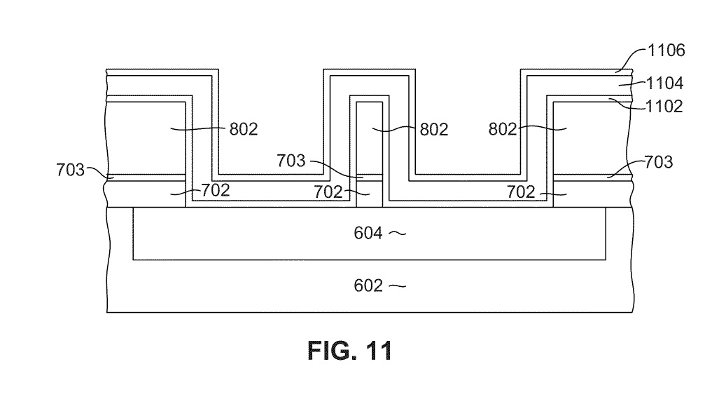

With reference to FIG. 10, a first ion milling is performed to remove portions of the sensor material that are not protected by the mask 802, thereby defining a sensor width (track width (TW)). Then, with reference to FIG. 11, a thin layer of electrically insulating material 1102 such as SiN, TaO, SiON, AlO, or MgO is deposited as single or multilayered stacks of each or combinations followed by a layer of hard magnetic material 1104. The insulation layer 1102 is preferably deposited to by a conformal deposition process such as atomic layer deposition ALD, Point Cusp Magnetrion (PCM) or ionized sputtering, or Controlled Incidence Angle Sputtering (CIS). The hard magnetic material 1104 is a high coercivity magnetic material such as CoPt and/or CoPtCr which can function as a strong permanent magnetic and may also include one or more seed layers (not shown). A second layer of material that is resistant to chemical mechanical polishing (second CMP stop layer) 1106, such as diamond like carbon (DLC) or amorphous carbon is deposited over the hard magnetic layer 1104.

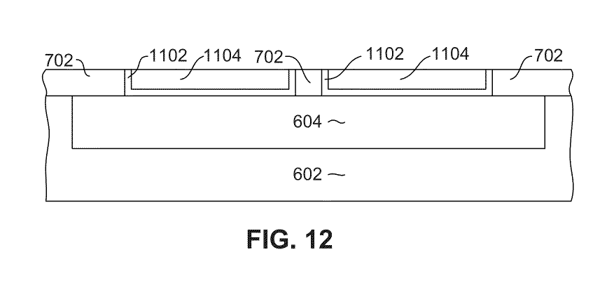

Thereafter, a series of processes are performed to remove the mask 802 and overlying portions of the insulation and hard bias layer 1104 to leave a planarized structure as shown in FIG. 12. These processes can include a wrinkle bake process, to remove the mask 802, a chemical mechanical polishing process to form a planar surface and a reactive on etching to remove the remaining CMP resistant layers 703, 1106, leaving a structure as shown in FIG. 12.

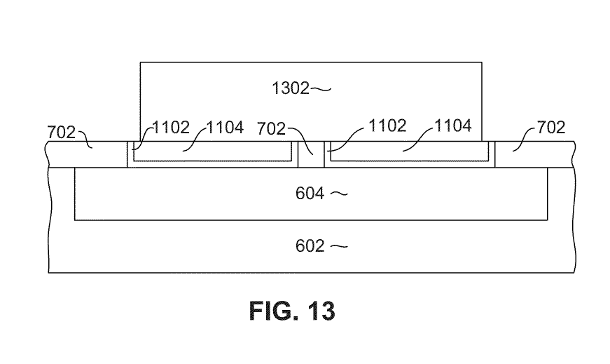

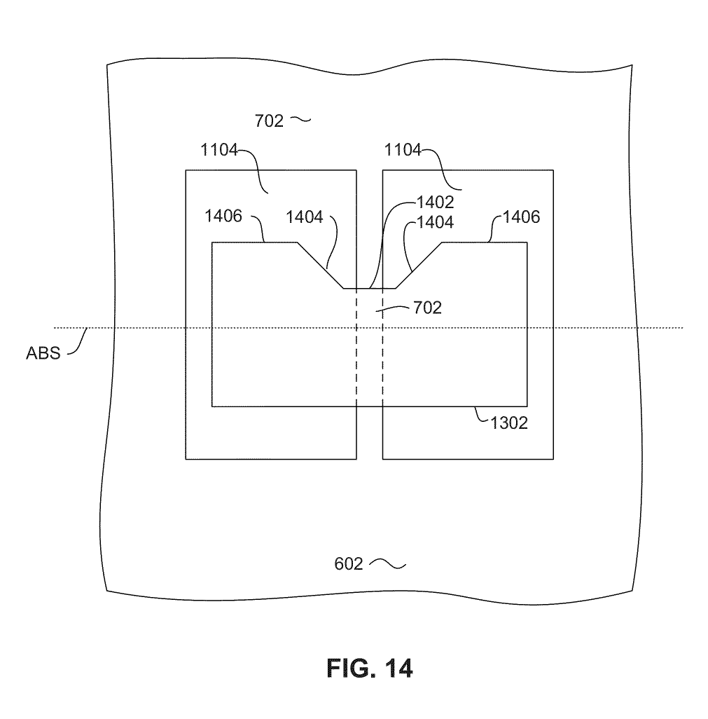

With reference now to FIG. 13, a second mask structure 1302 is formed. This mask structure 1302 also can include various layers (such as image transfer layer, hard mask, bottom anti-reflective coating (BARC) and photoresist) which are not shown individually for purposes of clarity. The configuration of the mask 1302 can be better understood with reference to FIG. 14, which shows a top down view of the structure of FIG. 13. As can be seen in FIG. 14, the mask 1302 has a straight back portion 1402 that extends across the sensor area to define a back edge of the sensor and also extends laterally somewhat beyond the sensor area 702 to define the neck portion of the hard mask (described above with reference to FIG. 4). The mask 1302 also includes a tapered portion 1404 that is formed at an angel (less than 90 degrees and greater than zero degrees) relative to an air bearing surface plane (ABS). The tapered portion 1404 preferably defines an angle of 60 degree nominal but can range 45-75 degrees relative to a plane that is parallel with the ABS. The mask 1302 may also have a straight outer portion back edge 1406, formed laterally beyond the tapered portion 1404.

Because the straight back portion 1402 extends beyond the sensor material 702, a certain amount of mask misalignment can be tolerated without adversely affecting the definition of sensor or the hard bias structure. It can be seen that if the mask 1302 were formed in an attempt to make the tapered edge 1404 extend all of the way to the sensor 702, then any slight misalignment would cause the back edge of the sensor 702 to taper away from the ABS at one side, thereby deforming the intended stripe height of the sensor. The design of the present invention overcomes this problem by allowing such mask misalignment with no detrimental effect to the sensor stripe height, while also providing the field strength advantages of having the tapered back edge 1404.

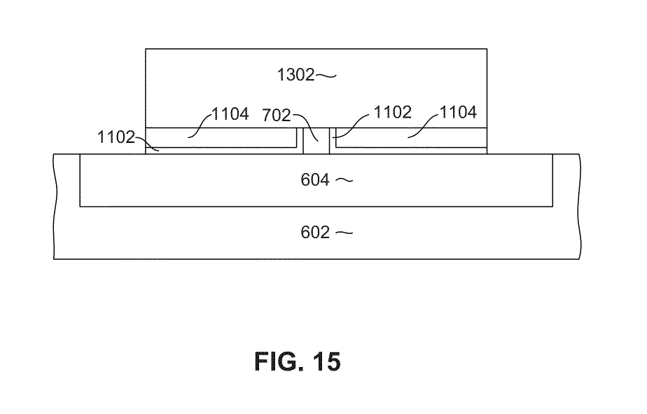

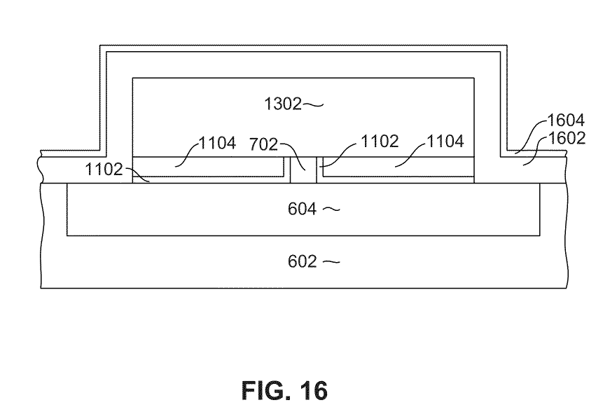

With the mask 1302 formed, a second ion milling operation is performed to remove portions of the sensor material 702, insulation layer 1102 and hard bias material 1104 that are not protected by the mask 1302, leaving a structure as show in FIG. 15. Then, with reference to FIG. 16, a non-magnetic, electrically insulating fill material such as alumina (Al₂O₃), TaO, SiN, or MgO) in single or multilayered stacks of each or combinations is deposited, followed by another layer of material that is resistant to chemical mechanical polishing (CMP stop layer) 1604. The fill layer 1602 is preferably deposited to a thickness that is about level with the top of the sensor layers 702. The CMP stop layer can be a material such as diamond like carbon (DLC) or amorphous carbon.

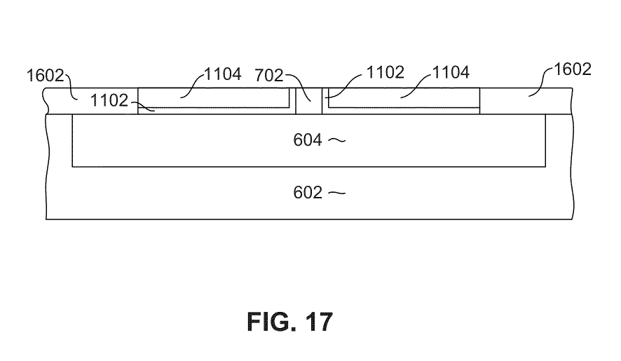

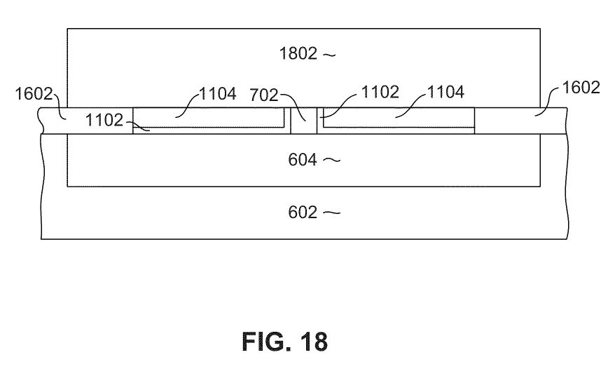

Then, a series of process are performed to remove the mask, form a planar surface and remove the remaining CMP stop material 1604 to leave a structure as shown in FIG. 17. These processes can include performing a wrinkle bake to remove the mask 1302, performing a CMP to planarize the surface and performing a reactive ion etching (RIE) to remove the remaining CMP stop material 1604. Then, with reference to FIG. 18, a top magnetic shield 1802 can be formed over the planarized surface. The top shield 1802 can be formed by electroplating and can be constructed of a material such as NiFe.

While various embodiments have been described above, it should be understood that they have been presented by way of example only and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A magnetic read head, comprising:
a sensor stack having a front edge facing an air bearing surface, a hack edge opposite the air hearing surface and first and second laterally opposed sides each extending from the front edge to the back edge;
a magnetic bias structure extending laterally from each of the first and second sides of the sensor stack, the bias structure having a throat portion with a back edge that is aligned with the back edge of the sensor stack and a tapered portion extending laterally outward from the throat portion, the tapered portion having a back edge that extends away from the air bearing surface and that defines an angel with respect to a plane that is parallel with the air bearing surface.

2. The magnetic read head as in claim 1 wherein the back edge of the tapered portion of the magnetic bias structure defines an angle of greater than 0 degrees and less than 90 degrees with respect to the plane that is parallel with the air bearing surface.

3. The magnetic read head as in claim 1 wherein the back edge of the tapered portion of the magnetic bias structure defines an angle 45-75 degrees with respect to the plane that is parallel with the air bearing surface.

4. The magnetic read head as in claim 1 wherein the back edge of the neck portion of the magnetic bias structure is parallel with the air bearing surface.

5. The magnetic read head as in claim 1 wherein the magnetic bias structure further includes an outer portion having a back edge that is substantially parallel with the air bearing surface.

6. The magnetic read head as in claim 1 wherein the outer portion of the magnetic bias structure extends laterally outward from the tapered portion.

7. The magnetic read head as in claim 1 wherein the magnetic bias structure comprises a magnetic material having a high magnetic coercivity.

8. The magnetic read head as in claim 1 wherein the magnetic bias structure comprises CoPt or CoPtCr.

9. The magnetic read head as in claim 1 wherein the magnetic bias structure is separated from the sensor stack by a thin non-magnetic, electrically insulating layer.

10. The magnetic read head as in claim 9 wherein the thin non-magnetic, electrically insulating layer comprises SiN, TaO, SiON, AlO, or MgO is deposited as single or multilayered stacks of each or combinations.

11. A method for manufacturing a magnetic read head, comprising:
depositing a series of sensor layers;
forming a first mask, configured to define a sensor width;
performing a first ion milling to remove portions of the series of sensor layers not protected by the first mask;
depositing a magnetic hard bias material;
removing the first mask;
forming a second mask configured to simultaneously define a back edge of the sensor and a hard bias structure having a throat portion with a back edge that is aligned with the back edge of the sensor and a tapered portion with a back edge oriented at an angle relative to an air bearing surface plane; and
performing a second ion milling to remove portions of the sensor material and magnetic hard bias material that are not protected by the second mask.

12. The method as in claim 11, further comprising, after performing the first ion milling and before depositing the magnetic hard bias material, depositing a nonmagnetic, electrically insulating layer.

13. The method as in claim 11, further comprising, after performing the first ion milling and before depositing the magnetic hard bias material, depositing SiN, TaO, SiON, AlO, or MgO is deposited as single or multilayered stacks of each or combinations.

14. The method as in claim 11 wherein the second mask is configured to define the back edge of the tapered portion to be oriented at an angle of less than 90 degrees and greater than 0 degrees relative to the air bearing surface plane.

15. The method as in claim 11 wherein the second mask is configured to define the back edge of the tapered portion to be oriented at an angle of 45-75 degrees relative to the air bearing surface plane.

16. The method as in claim 11 wherein the magnetic hard bias material comprises a magnetic material having a high magnetic coercivity.

17. The method as in claim 11 wherein the magnetic hard bias material comprises CoPt or CoPtCr.

18. The method as in claim 11 wherein the first mask structure is formed and the first ion milling performed before the second mask structure is formed and the second ion milling is performed.

19. The method as in claim 11 wherein the second mask is further configured to define the hard bias structure with an outer portion that has a back edge that is substantially parallel with the air bearing surface plane.

20. The method as in claim 11 further comprising, after removing the first mask and before forming the second mask, performing a chemical mechanical polishing.
